(19) United States
(12) Patent Application Publication
(10) Pub. No.: US 2024/0373118 A1
(43) Pub. Date: Nov. 7, 2024

(54) GIMBAL CONTROL METHOD AND APPARATUS, AND MOVABLE PLATFORM AND COMPUTER-READABLE MEDIUM

(71) Applicant: SZ DJI TECHNOLOGY CO., LTD., Shenzhen (CN)

(72) Inventors: Guhong NIE, Shenzhen (CN); Xiaoxiang HU, Shenzhen (CN); Yana GUO, Shenzhen (CN)

(21) Appl. No.: 18/778,458

(22) Filed: Jul. 19, 2024

Related U.S. Application Data
(63) Continuation of application No. PCT/CN2022/073262, filed on Jan. 21, 2022.

(51) Int. Cl. H04N 23/611; G03B 17/56; H04N 23/62; H04N 23/63; H04N 23/67; H04N 23/695

(52) U.S. Cl. CPC H04N 23/611; H04N 23/62; H04N 23/632; H04N 23/67; H04N 23/695; G03B 17/561

(57) ABSTRACT

A control method includes obtaining one or more target body key points from a shot image collected by a shooting apparatus carried by a gimbal and controlling the gimbal to adjust an attitude and/or controlling the shooting apparatus to adjust a shooting parameter according to the one or more target body key points. The one or more target body key points are used to indicate a body part of the target object. The gimbal is configured to carry the shooting apparatus and drive the shooting apparatus to rotate to adjust the attitude of the shooting apparatus.

### CROSS-REFERENCE TO RELATED APPLICATION

This application is a continuation of International Application No. PCT/CN2022/073262, filed Jan. 21, 2022, the entire content of which is incorporated herein by reference.

### TECHNICAL FIELD

The present disclosure relates to the control technology and, more particularly, to a gimbal control method, a gimbal control apparatus, a gimbal, and a computer-readable medium.

### BACKGROUND

When using a handheld gimbal for recording, a user fixes the handheld device with a tripod to allow the user to enter a user-follow mode through an interaction method such as a gesture. In this status, the handheld gimbal centers a target image according to the target following frame information in an image.

Currently, in the existing following method, a full body or a half body of a person is followed, which is relatively rough, is only suitable for a long-distance scene or medium-distance scene, and is not able to precisely follow a partial close-up.

### SUMMARY

In accordance with the disclosure, there is provided a control method. The method includes obtaining one or more target body key points from a shot image collected by a shooting apparatus carried by a gimbal and controlling the gimbal to adjust an attitude and/or controlling the shooting apparatus to adjust a shooting parameter according to the one or more target body key points. The one or more target body key points are used to indicate a body part of the target object. The gimbal is configured to carry the shooting apparatus and drive the shooting apparatus to rotate to adjust the attitude of the shooting apparatus.

Also in accordance with the disclosure, there is provided a gimbal control device, including one or more processors and one or more memories. The one or more memories store executable instructions that, when executed by the one or more processors, cause the one or more processors to display a shot image in a user interface and detect one or more body key points of the target object according to the shot image collected by a shooting apparatus carried by a gimbal, in response to a selection operation performed on the user interface, determining one or more target body key points from the one or more body key points, and control the gimbal to adjust an attitude and/or controlling the shooting apparatus to adjust a shooting parameter according to the one or more target body key points. The body key points are configured to indicate a body part of the target object. The gimbal is configured to carry the shooting apparatus and drive the shooting apparatus to rotate to adjust an attitude of the shooting apparatus.

Also in accordance with the disclosure, there is provided a gimbal, including a gimbal control device. The gimbal control device includes one or more processors and one or more memories. The one or more memories store executable instructions that, when executed by the one or more processors, cause the one or more processors to display a shot image in a user interface and detect one or more body key points of the target object according to the shot image collected by a shooting apparatus carried by a gimbal, in response to a selection operation performed on the user interface, determining one or more target body key points from the one or more body key points, and controlling the gimbal to adjust an attitude and/or controlling the shooting apparatus to adjust a shooting parameter according to the one or more target body key points. The body key points are configured to indicate a body part of the target object. The gimbal is configured to carry the shooting apparatus and drive the shooting apparatus to rotate to adjust an attitude of the shooting apparatus.

### BRIEF DESCRIPTION OF THE DRAWINGS

FIG. 1 is a schematic flowchart of a gimbal control method consistent with an embodiment of the present disclosure.

FIG. 2 is a schematic flowchart of a method for performing adjustment according to a human body key point consistent with an embodiment of the present disclosure.

FIG. 3 is a schematic flowchart of a method for performing adjustment further according to a human body key point consistent with an embodiment of the present disclosure.

FIG. 4 is a schematic flowchart of a gimbal control method in an application scenario consistent with an embodiment of the present disclosure.

FIG. 5 is a schematic structural diagram of a gimbal control device consistent with an embodiment of the present disclosure.

### DETAILED DESCRIPTION OF THE EMBODIMENTS

Embodiments of the present disclosure are described in detail in connection with the accompanying drawings. However, embodiments of the present disclosure can be implemented in various methods and should not be limited to examples described here. On the contrary, embodiments of the present disclosure are provided to make the present disclosure clearer and convey the concept of exemplary embodiments to those skilled in the art. Described features, structures, or characteristics can be combined in one or more embodiments in any suitable method. In the following description, details are provided to understand the present disclosure. However, those skilled in the art can understand that one or more details can be omitted by implementing the technical solution of the present disclosure, or other methods, elements, apparatuses, or steps can be adopted. In some other embodiments, the well-known technical solutions are not shown or described in detail to avoid obscuring the aspects of the present disclosure.

The terms “a,” “an,” “the,” and “the” used in this specification can be used to indicate the presence of one or more elements/components/etc. The terms “include” and “have” are used to represent an open-ended including meaning and mean other elements/components/etc., can be included in addition to the elements/components/etc., that are listed. The terms “first,” “second,” etc. are used merely as labels and do not limit the number of the objects of the terms.

Moreover, the accompanying drawings are merely schematic illustrations of the present disclosure and are not necessarily drawn according to a ratio. The same reference numbers in the drawings can denote the same or similar parts. Thus, the repetitive description of the same or similar parts can be omitted. Some block diagrams shown in the accompanying drawings can represent functional entities, which do not necessarily correspond to physically or logically separate entities.

For the problems in the related technology, the present disclosure provides a gimbal control method, a gimbal control device, a gimbal, and a computer-readable medium. Various aspects of exemplary embodiments of the present disclosure are described in detail below.

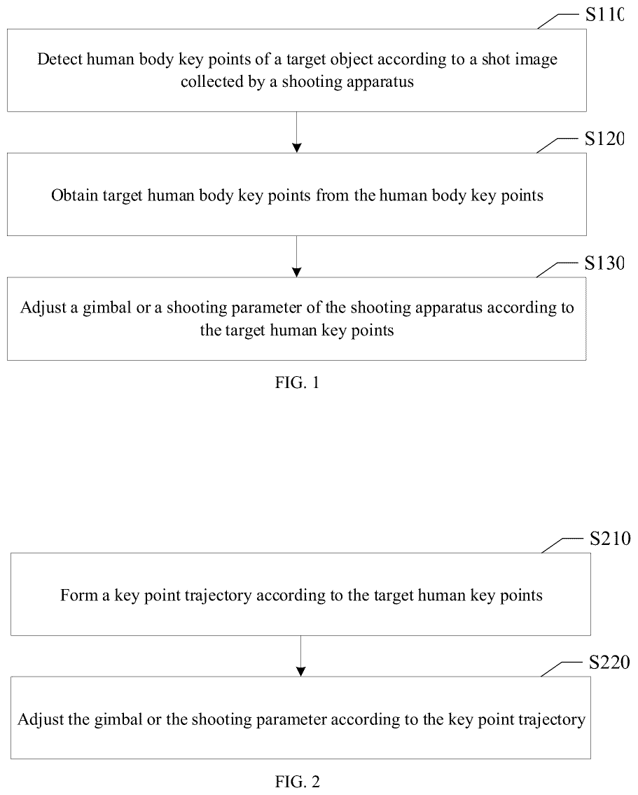

FIG. 1 is a schematic flowchart of a gimbal control method consistent with an embodiment of the present disclosure. In the example shown in FIG. 1, a gimbal is configured to carry a shooting apparatus and drive the shooting apparatus to rotate to adjust the recording direction of the shooting apparatus. The shooting apparatus can provide a user interface. The method includes at least processes S110, S120, and S130.

At S110, human body key points of a target object are detected according to a shot image collected by the shooting apparatus.

At S120, a target human body key point is obtained from the human body key points.

At S130, the gimbal or a shooting parameter is adjusted according to the target human body key point.

In some embodiments, obtaining the target human body key point can include displaying the human body key points on the user interface, obtaining a selection operation of the user on the user interface, and determining the target human body key point according to the selection operation.

In some embodiments, obtaining the target human body key points can include determining the target human body key point according to a predetermined template.

In some embodiments, obtaining the target human body key point can include determining the target human body key point according to a predetermined key point type.

In embodiments of the present disclosure, the gimbal or the shot image can be adjusted according to the human body key points determined through the user interaction. Thus, the gimbal can perform intelligent smooth adjustment and change the focus smoothly, which solves the problems of image shaking, unsmooth switching, defocusing, and image blurring. Thue, the intelligent and automatic degree of the application of the gimbal can be improved, and the learning cost, labor cost, and operation complexity can be reduced in the application of the gimbal. The photographing effect can be optimized with a single user, the user experience can be optimized, and user retention can be improved to a certain degree.

The processes of the gimbal control method are described in detail as follows.

In process S110, the human body key points of the target object are detected according to the shot image collected by the shooting apparatus.

In embodiments of the present disclosure, the gimbal can be driven by a plurality of electrical motors. The gimbal can be a two-axis gimbal or a three-axis gimbal. For example, for the three-axis gimbal, the three-axis gimbal can include a yaw-axis motor, a roll-axis motor, and a pitch-axis motor.

The gimbal can carry the shooting apparatus. The shooting apparatus can include a user interface. For instance, the shooting apparatus can include a camera, a mobile phone, an optical lens such as an image sensor, etc. The gimbal can at least rotate about the yaw axis to drive the shooting apparatus to rotate in the yaw direction to adjust the shooting direction of the shooting apparatus.

The user interface (UI) can be a medium for interaction and information exchange between the system and the user, which realizes the conversion of the information between an internal format and the human acceptable format. The UI can be related software designed for the mutual communication between the user and the hardware and is intended to cause the user to operate the hardware conveniently and effectively to realize mutual interaction to complete the operation with the help of the hardware. The UI can be broadly defined and include a human-machine graphic user interface. The UI exists in fields involving information exchange between human and machine.

Further, the current shot image of the shooting apparatus can be displayed within the UI to detect the human body key points of the target object in the shot image. For example, the target object can be a person.

In some embodiments, skeletal point detection can be performed on the shot image to obtain the human body key points of the target object in the image.

The skeletal point detection can be Pose Estimation, which is mainly used to detect some key points of the human body, e.g., joints and facial features, to outline the human body skeletal information through the human body key points.

In some embodiments, the shot image can be input into a pre-trained Convolutional Neural Network (CNN) to obtain an information set of the human body skeletal key points as the human body key points. The CNN can include CNNs with various structures, such as a Region-CNN (R-CNN), a Spatial Transformer Network (STN), etc., which is not limited in embodiments of the present disclosure.

In addition, an OpenPose method can be used to extract human body skeletal key point information, including 18 key points of the human body skeleton, such as left eye, right eye, left ear, right ear, mouth, left shoulder, right shoulder, chest neck, left elbow, right elbow, left hand, right hand, left hip, right hip, left knee, right knee, left foot, and right foot.

In some embodiments, the human body key points can be determined in the shot image in the Pose Estimation, which can be fast and accurate and provide a data basis and theoretical basis for subsequently adjusting the gimbal or shot image.

In process S120, the target human body key point is obtained in the human body key points.

In some embodiments, after determining the human body key points in the shot image, the user can further determine the target human body key point through a selection operation.

In some embodiments, the human body key points in the shot image can be determined according to the selection operation.

The selection operation can include a click operation, a long press operation, a swipe operation, or other non-contact operations, which is not limited in embodiments of the present disclosure.

Thus, the user can perform the selection operation on the user interface to select the currently required human body key points from the detected human body key points. The user can also select all the detected body key points through the selection operation.

In some embodiments, the human body key points can be determined in the shot image according to the key point template.

The key point template can be pre-determined. The human body key points can be selected in different situations. For example, the key point template can be determined for the part of the target object included in the shot image, according to the background where the target object included in the shot image is, or through self-selection when the user uses the template for the first time. Embodiments of the present disclosure do not limit the generation methods and specific types of the key point template.

Based on this, the user can select the currently desired key point template through the selection operation performed on the user interface to determine the human body key points in the shot image using the key point template.

In some other embodiments, the human body key points can be automatically determined in the shot image through the pre-determined key point type.

For example, the key points can be identified, the movement statuses of the key points can be obtained, and the human body key points can be automatically determined in the shot image. For example, the movement speeds of the key points can be identified, and the human body key points can be automatically determined in the shot image.

After detecting the human body key points, the user-selected human body key points may be lost during the user shooting process. For example, a following confidence level can be determined according to a following confidence level determination threshold to determine whether the human body key points are lost.

In some embodiments, the value range of the following confidence level can be set to between 0 and 1, where 0 indicates the lowest confidence level of the human body key points during the shooting process, and 1 indicates the highest confidence level of the human body key points during the shooting process. The following confidence level determination threshold can be set according to actual situations and needs.

When the following confidence level is greater than the following confidence level determination threshold, the body key points can be determined to be not lost, and shooting can continue. When the following confidence level is less than or equal to the following confidence level determination threshold, the body key points can be determined to be lost, and the human body key points can be re-acquired.

In some embodiments, correspondence and matching can be performed according to coordinate information of the human body key points in the image before the human body key points are lost and all the detected human body key points to re-positioning the lost human body key points according to matching results. In addition, other methods for re-acquiring the lost human body key points can exist, which are not limited in embodiments of the present disclosure.

In process S130, the gimbal or the shooting parameter is adjusted according to the target human body key point.

In some embodiments, after the user determines the target human body key point, the gimbal or the current shooting parameter can be further adjusted according to the target human body key point.

In some embodiments, FIG. 2 is a schematic flowchart of a method for performing adjustment according to human body key points consistent with an embodiment of the present disclosure. As shown in FIG. 2, the method includes at least the following processes.

At S210, a key point trajectory is formed according to the target human body key points.

After the user selects the target human body key points, the key point trajectory can be formed by connecting the target human body key points. In some embodiments, the key point trajectory can be a trajectory formed by different key points in a same image or a plurality of images. In some other embodiments, the key point trajectory can be a trajectory formed by the same key point in the plurality of images.

The method for forming the key point trajectory according to the target human body key points can include connecting the same human body key point according to a time sequence within a predetermined time length. The predetermined time length can be Is or other time lengths, which is not limited in embodiments of the present disclosure.

The formed key point trajectory can include a determined trajectory formed by the same human body key point within the predetermined time length and also include a predicted subsequent trajectory.

At S220, the gimbal or the shooting parameter is adjusted according to the key point trajectory.

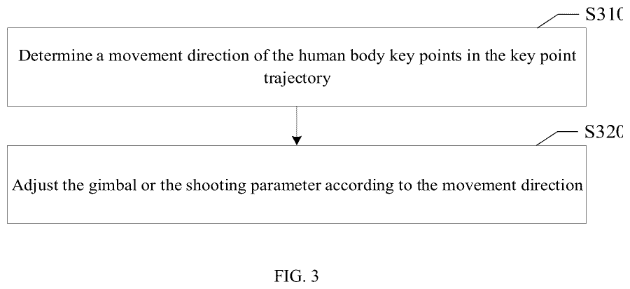

In some embodiments, FIG. 3 is a schematic flowchart of a method for performing adjustment further according to a human body key point consistent with an embodiment of the present disclosure. As shown in FIG. 3, the method includes at least the following processes.

At S310, the movement direction of the human body key points of the key point trajectory is determined.

The key point trajectory formed through connection can reflect the movement direction of the human body key points. The movement direction can be the movement direction of one or more human body key points of the target object.

In some embodiments, the movement direction can include a forward-backward direction, a horizontal direction, and a vertical direction.

The movement direction can be a direction formed according to the human body key points relative to the shooting apparatus. In some embodiments, when the human body key points have changes in the distance further from and closer to the shooting apparatus, the movement direction of the human body key points in the key point trajectory can be determined as the forward and backward direction. When the human body key points move on the horizontal plane where the shooting apparatus is or on a plane parallel to the horizontal plane, the movement direction of the human body key points of the key point trajectory can be the horizontal direction. When the human body key points move on the vertical plane where the shooting apparatus is, the movement direction of the human body key points of the key point trajectory can be the vertical direction.

In some embodiments, the movement of the key points can include a movement in a plurality of directions, such as front-left, back-right, etc. The gimbal can be controlled according to various combinations.

For instance, if the target object moves from back to front, or a hand of the target object waves from front to back, the movement direction of the human body key points can be determined to be the front-back direction according to the key point trajectory. When the target object waves the hand, the movement direction of the human body key points can be determined to be the horizontal direction according to the key point trajectory. When the target object moves the hand from the head to the waist, the movement direction of the human body key points can be determined to be the vertical direction according to the key point trajectory. In addition, other methods for determining the movement direction of the human body key points according to the key point trajectory can be provided, which are not limited in embodiments of the present disclosure.

At S320, the gimbal or the shooting parameter is adjusted according to the movement direction.

In some embodiments, if the movement direction is the front-back direction, the focus of the shooting apparatus is adjusted.

When the movement direction of the human body key points is the front-back direction, the focus of the shooting apparatus can be adjusted. In some embodiments, the method for adjusting the focus of the shooting apparatus can include zooming in on the target object or changing the background of the target object while keeping the target object unchanged. For example, the background of the target object can get farther away from close by.

In some embodiments, if the movement direction is the horizontal direction, the yaw angle of the gimbal can be adjusted.

In some embodiments, the yaw angle can rotate about z-axis. Yaw can mean rotating around a gravity direction as an axis.

Therefore, when the movement direction is the horizontal direction, the yaw angle of the gimbal can be adjusted corresponding to the movement direction of the target object. Thus, the gimbal can perform intelligent smooth adjustment on the yaw angle.

In some embodiments, if the movement direction is the vertical direction, the pitch angle of the gimbal can be adjusted.

Therefore, when the movement direction is the vertical direction, the pitch angle of the gimbal can be adjusted corresponding to the movement direction of the target object. Thus, the gimbal can perform the intelligent smooth adjustment on the pitch angle.

In some embodiments, according to the movement direction represented by the key point trajectory, the angle of the gimbal or the focus of the shooting apparatus can be adjusted correspondingly. Thus, the gimbal can perform intelligent smooth adjustment and change the focus smoothly to improve the intelligent and automatic degree of the gimbal application, and reduce the learning cost and operation complexity during the process of the user using the gimbal. Moreover, the gimbal can be used by a single person conveniently. The image effect of the shot image can be optimized, the user experience can be optimized, and the user loyalty can be improved.

When the human body key points are lost, adjusting the gimbal or the shooting parameter according to the key point trajectory in process S220 can include performing the adjustment according to the predicted key point trajectory.

During this process, the time length in which the human body key points are lost can be calculated. When the time length in which the human body key points are lost is greater than the corresponding predetermined time length threshold, the gimbal can be controlled to stop rotating.

The gimbal control method of embodiments of the present disclosure can be described in detail below in connection with an application scenario.

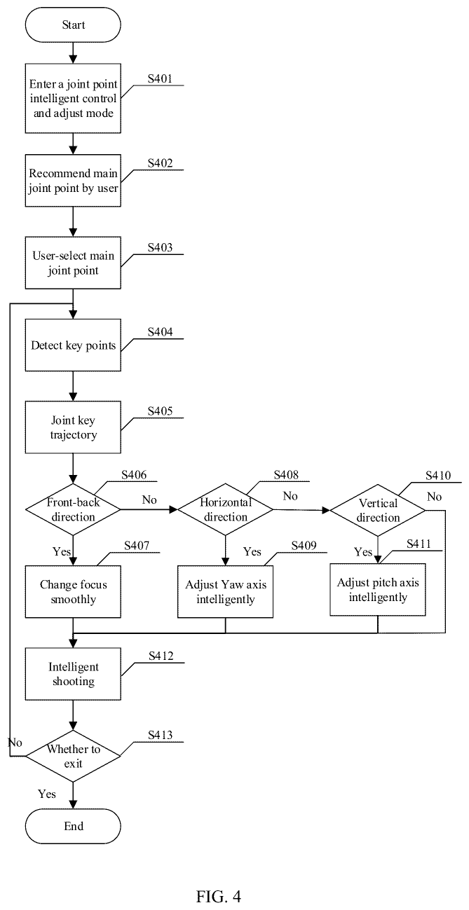

FIG. 4 is a schematic flowchart of the gimbal control method in an application scenario consistent with an embodiment of the present disclosure. As shown in FIG. 4, at S401, a key point intelligent control mode is entered.

In the joint point intelligent control mode, computer vision can be used to analyze the human body key points of the target object, the user can be regularly guided through the user interface of the shooting apparatus carried by the gimbal to cause the user to identify a user simple operation using the vision algorithm.

The gimbal can carry the shooting apparatus. The shooting apparatus can include the user interface. For example, the shooting apparatus can include a camera, a mobile phone, or an optical lens including the image sensor. The gimbal can at least rotate around the yaw-axis to drive the shooting apparatus to rotate in the yaw direction and adjust the shooting direction of the shooting apparatus.

At S402, the user recommends the main key point.

After identifying the human body key points in the shot image, the user can continue to determine the human body key points through the selection operation.

The human body key points in the shot image can be determined according to the key point template.

The key point template can be predetermined. The human body key points can be selected in different situations. For example, the key point template can be determined for the part of the target object included in the shot image, according to the background where the target object included in the shot image is, or through self-selection when the user uses the template for the first time. Embodiments of the present disclosure do not limit the generation methods and specific types of the key point template.

Based on this, the user can select the currently desired key point template through the selection operation performed on the user interface to determine the human body key points in the shot image using the key point template.

At S403, the user selects the main key points.

After determining the human body key points in the shot image according to the key point template, the user can continue to re-select and adjust the human body key points included in the key point template through the selection operation, or the user can select the human body key points according to the selection operation, which is not limited in embodiments of the present disclosure.

The selection operation can include the click operation, the long press operation, the swipe operation, or other non-contact operations, which are not limited in embodiments of the present disclosure.

The user selected human body key points can be lost during the user shooting process. For example, the following confidence level can be determined using the following confidence level determination threshold to determine whether the human body key points are lost.

In some embodiments, the value range of the following confidence level can be set to between 0 and 1, where 0 indicates the lowest confidence level of the human body key points during the shooting process, and 1 indicates the highest confidence level of the human body key points during the shooting process. The following confidence level determination threshold can be set according to actual situations and needs.

When the following confidence level is greater than the following confidence level determination threshold, the body key points can be determined to be not lost, and shooting can continue. When the following confidence level is less than or equal to the following confidence level determination threshold, the body key points can be determined to be lost, and the human body key points can be re-acquired.

In some embodiments, one-to-one correspondence and matching can be performed according to coordinate information of the human body key points in the image before the human body key points are lost and all the detected human body key points to re-positioning the lost human body key points according to matching results. In addition, other methods for re-acquiring the lost human body key points can exist, which are not limited in embodiments of the present disclosure.

At S404, the key points are detected.

Furthermore, the current shot image of the shooting apparatus can be displayed in the user interface to detect the human body key points corresponding to the target object in the shot image according to the user selected human body key points. For example, the target object can be a person.

In some embodiments, the skeletal point detection can be performed on the shot image to obtain the human body key points of the target object in the shot image.

The skeletal point detection can be Pose Estimation, which is mainly used to detect some key points of the human body, e.g., joints and facial features, to outline the human body skeletal information through the human body key points.

In some embodiments, the shot image can be input into the pre-trained Convolutional Neural Network (CNN) to obtain the information set of the human body skeletal key points as the human body key points. The CNN can include CNNs with various structures, such as a Region-CNN (R-CNN), a Spatial Transformer Network (STN), etc., which is not limited in embodiments of the present disclosure.

In addition, an OpenPose method can be used to extract human body skeletal key point information, including 18 key points of the human body skeleton, such as left eye, right eye, left ear, right ear, mouth, left shoulder, right shoulder, chest neck, left elbow, right elbow, left hand, right hand, left hip, right hip, left knee, right knee, left foot, and right foot.

At S405, the key point trajectory is obtained.

After the user selected human body key points are detected, the human body key points can be connected to form the key point trajectory. In some embodiments, the method for connecting the human body key points can include a user manual connection or an automatic connection according to the key point template or other methods, which are not limited in embodiments of the present disclosure.

At S406, the font-back direction is detected.

The key point trajectory formed through connection can reflect the movement direction of the human body key points. The movement direction can be the moving direction of the target object.

In some embodiments, the movement direction can include the front-back direction. For example, when the target object moves from back to front, or the hand of the target object waves from front to back, the movement direction of the human body key points can be determined to be the front-back direction according to the key point trajectory.

At S407, the focus is changed smoothly.

If the movement direction is the front-back direction, the focus of the shooting apparatus can be adjusted.

When the movement direction of the human body key points is the front-back direction, the focus of the shooting apparatus can be adjusted. In some embodiments, the method for adjusting the focus of the shooting apparatus can include zooming in on the target object or changing the background of the target object while keeping the target object unchanged. For example, the background of the target object can change from close to far away.

At S408, the horizontal direction is detected.

In some embodiments, the movement direction can include the horizontal direction. When the target object moves the hand from the chest to a full extension, the movement direction of the human body key points can be determined as the horizontal direction according to the key point trajectory.

At S409, the yaw axis is adjusted intelligently.

If the movement direction is the horizontal direction, the yaw angle of the gimbal can be adjusted.

Thus, when the movement direction is the horizontal direction, the yaw angle of the gimbal can be adjusted corresponding to the movement direction of the target object to cause the gimbal to adjust the yaw angle intelligently and smoothly.

At S410, the vertical direction is detected.

In some embodiments, the movement direction can include the vertical direction. When the target object moves the hand from the head to the waist, the movement direction of the human body key points can be determined as the vertical direction according to the key point trajectory.

At S411, the pitch axis is adjusted intelligently.

If the movement direction is the vertical direction, the pitch angle of the gimbal can be adjusted.

Thus, when the movement direction is the vertical direction, the pitch angle of the gimbal can be adjusted corresponding to the movement direction of the target object to cause the gimbal to adjust the pitch angle intelligently and smoothly.

When the identified movement direction includes a movement in various directions, e.g., front-left, back-right, etc. The gimbal can be controlled according to various combinations. For instance, when the movement direction includes the horizontal direction and the vertical direction, a target attitude point of the gimbal can be determined according to the two directions. The gimbal can be controlled according to the target attitude point. When the movement direction includes the horizontal direction and the front-back direction, the target attitude point of the gimbal can be determined according to the movement in the horizontal direction. The gimbal can be controlled according to the target attitude point. The target parameter of the shooting apparatus can be determined according to the movement in the front-back direction, and the shooting apparatus can be controlled according to the target parameter.

At S412, the intelligent shooting is performed.

After the gimbal or the shot image is adjusted according to the key point trajectory of the human body key points, the shooting phase can be entered using the gimbal.

At S413, whether to exit is determined.

When completing the shooting according to the determined human body key points, the user can exit from the identified target human body key points. Re-selection and detection can be performed to continue with the next intelligent shooting.

When the user completes the shooting according to the human body key points that are determined this time, the user can exit the identified target human body key points and perform re-selection and detection to continue with the next intelligent shooting.

In some embodiments, following shooting can be performed by identifying the human body key points. Compared to following shooting for the whole human body, the following lost can be avoided when a part of the human body is blocked. In addition, identifying the human body key points to perform the following shooting can cause the image to focus more on local details to represent a richer image effect.

In some embodiments, the gimbal or the shot image can be adjusted according to the human body key points determined through the user interaction. Thus, the gimbal can perform intelligent and smooth adjustments and change the focus smoothly, which solves the problems of image shaking, unsmooth switching, defocusing, and image blurring. Thus, the intelligent and automatic degree of the application of the gimbal can be improved, and the learning cost, labor cost, and operation complexity can be reduced in the application of the gimbal. The photographing effect can be optimized with a single user, the user experience can be optimized, and user retention can be improved to a certain degree.

Although the above embodiments are described the processes of the method of the present disclosure in a certain order, the processes are not required to be performed according to a certain order, or the processes are not required to be performed to realize the expected results. In some embodiments, some processes can be omitted, a plurality of processes can be combined into one process, and/or one processes can be divided into a plurality of processes.

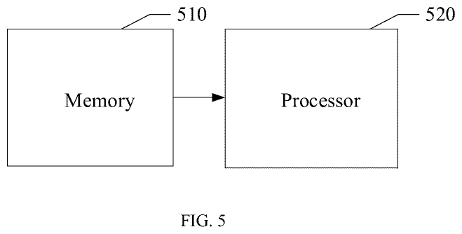

In addition, embodiments of the present disclosure further provide a gimbal control device. The gimbal can be configured to carry the shooting apparatus and drive the shooting apparatus to rotate to adjust the shooting direction of the shooting apparatus. The shooting apparatus can provide the user interface. FIG. 5 is a schematic structural diagram of the gimbal control device consistent with an embodiment of the present disclosure. As shown in FIG. 5, the gimbal control device includes one or more memories 510 and one or more processors 520.

The one or more memories 510 can be used to store executable instructions for the one or more processors 520.

The one or more processors 520 can be configured to perform the executable instructions to detect the human body key points of the target object according to the shot image collected by the shooting apparatus, obtain the target human body key points from the human body key points, and adjust the gimbal or the shooting parameter according to the target human body key points.

In some embodiments, the adjusting the gimbal or the shooting parameter of the shooting apparatus according to the target human body key points can include forming the key point trajectory according to the target human body key point and adjusting the gimbal or the shooting parameter according to the key point trajectory.

In some embodiments, adjusting the gimbal or the shooting parameter according to the key point trajectory can include determining the movement direction of the human body key points of the key point trajectory and adjusting the gimbal or the shooting parameter according to the movement direction.

In some embodiments, the movement direction can include the front-back direction, the horizontal direction, and the vertical direction.

In some embodiments, adjusting the gimbal or the shooting parameter according to the movement direction can include if the movement direction is the front-back direction, adjusting the focus of the shooting parameter.

In some embodiments, adjusting the gimbal or the shooting parameter according to the movement direction can include if the movement direction is the horizontal direction, adjusting the yaw angle of the gimbal.

In some embodiments, adjusting the gimbal or the shooting parameter according to the movement direction can include if the movement direction is the vertical direction, adjusting the pitch angle of the gimbal.

In some embodiments, determining the target human body key points in the shot image can include determining the target human body key points in the shot image according to the selection operation.

In some embodiments, determining the target human body key points in the shot image can include determining the target human body key points in the shot image according to the key point template.

In some embodiments, detecting the human body key points of the target object in the shot image can include performing the skeletal detection on the shot image to obtain the human body key points of the target object in the shot image.

The gimbal control device is described in detail in the description of the gimbal control method and thus is not repeated here.

In the gimbal control device of embodiments of the present disclosure, the gimbal or the shot image can be adjusted by the human body key points determined through the user interaction. Thus, the gimbal can perform intelligent and smooth adjustment and change the focus smoothly, which solves the problems of image shaking, unsmooth switching, defocusing, and image blurring. Thus, the intelligent and automatic degree of the application of the gimbal can be improved, and the learning cost, labor cost, and operation complexity can be reduced in the application of the gimbal. The photographing effect can be optimized with a single user, the user experience can be optimized, and user retention can be improved to a certain degree.

Embodiments of the present disclosure provide a gimbal device. The gimbal device can include a gimbal, a base, and the above gimbal control device. The gimbal can be configured to carry the shooting apparatus and can be connected to the base. The gimbal control device can perform the gimbal control method with the principle and implementation manner consistent with the above embodiments, which are not repeated here.

Embodiments of the present disclosure can further provide a computer-readable medium, which stores a computer program. When the computer program is executed by the processor, any one of the gimbal control methods of embodiments of the present disclosure can be realized, e.g., the method processes in FIG. 1.

The computer-readable medium can be included in the mobile object of embodiments of the present disclosure or exist alone without being mounted in the movable object.

The computer-readable medium can be a computer-readable signal medium or a computer-readable storage medium or any combination thereof. For example, the computer-readable storage medium can include, but is not limited to, electrical, magnetic, optical, electromagnetic, infrared, or semiconductor systems, devices, or apparatuses, or any combination thereof. Specific examples of the computer-readable storage medium include, but are not limited to, electrical connections with one or more wires, portable computer disks, hard disks, random access memory (RAM), read-only memory (ROM), erasable programmable read-only memory (EPROM or flash memory), optical fibers, portable compact disc read-only memory (CD-ROM), optical storage devices, magnetic storage devices, or any suitable combination thereof. In the present disclosure, the computer-readable storage medium can be any tangible medium including or storing a program, which can be used or in conjunction with an instruction execution system, apparatus, or device. In the present disclosure, the computer-readable signal medium can include any computer-readable medium other than a computer-readable storage medium that transmits, propagates, or transmits a program used by or in conjunction with an instruction execution system, apparatus, or device. Program code on the computer-readable medium can be transmitted using any suitable medium, including but not limited to wireless, wired, optical cable, RF, etc., or any suitable combination thereof.

Through the descriptions of embodiments of the present disclosure, those skilled in the art will understand that the exemplary embodiments described here can be implemented by software, or the software in combination with necessary hardware. Therefore, the technical solutions of embodiments of the present disclosure can be embodied in the form of a software product. The software product can be stored in a non-volatile storage medium (e.g., a CD-ROM, USB disk, mobile hard disk, etc.) or in a network, including several instructions to enable a computing device (e.g., a personal computer, server, terminal device, or network device, etc.) to execute the methods of embodiments of the present disclosure.

In addition, the accompanying drawings are merely illustrative of the processes included in the methods according to the exemplary embodiments of the present disclosure and are not for limiting purposes. The processes shown in the accompanying drawings do not indicate or limit the order of the processes. In addition, The processes can be performed synchronously or asynchronously in a plurality of modules.

Although several modules or units for action execution are mentioned in the detailed description above, such division is not mandatory. In fact, the features and functions of two or more modules or units described above can be embodied in one module or unit according to the exemplary embodiments of the present disclosure. On the contrary, the features and functions of one module or unit described above can be further divided into multiple modules or units.

Those skilled in the art, after considering the specification and practicing the disclosed invention, will easily think of other embodiments of the present disclosure. This application is intended to cover any variations, uses, or adaptations of this disclosure following its general principles and including common general knowledge or conventional technical means in the field not disclosed herein. The specification and examples are considered exemplary, and the true scope and spirit of the present disclosure are indicated by the claims.

The present disclosure is not limited to the precise structure described above and shown in the accompanying drawings, and various modifications and changes can be made without departing from its scope. The scope of the present disclosure is limited only by the appended claims.

What is claimed is:

1. A control method comprising:
obtaining one or more target body key points from a shot image collected by a shooting apparatus carried by a gimbal, the one or more target body key points being used to indicate a body part of the target object; and
controlling the gimbal to adjust an attitude and/or controlling the shooting apparatus to adjust a shooting parameter according to the one or more target body key points, the gimbal being configured to carry the shooting apparatus and drive the shooting apparatus to rotate to adjust the attitude of the shooting apparatus.

2. The method of claim 1, wherein adjusting the gimbal or the shooting parameter includes:
in response to movement of the one or more target body key points in the shot image, obtaining a key point trajectory; and
controlling the gimbal to adjust the attitude and/or controlling the shooting apparatus to adjust the shooting parameter according to the key point trajectory.

3. The method of claim 2, wherein:
the one or more target body key points include a plurality of target body key points; and
the key point trajectory includes movement trajectories of the plurality of target body key points in a plurality of images.

4. The method of claim 2, wherein controlling the gimbal to adjust the attitude and/or controlling the shooting apparatus to adjust the shooting parameter according to the key point trajectory includes:
determining one or more movement directions of the one or more target body key points in the key point trajectory; and
controlling the gimbal to adjust the attitude and/or controlling the shooting apparatus to adjust the shooting parameter according to the one or more movement directions.

5. The method of claim 4, wherein each of the one or more movement directions includes a front-back direction, a horizontal direction, or a vertical direction.

6. The method of claim 5, wherein controlling the gimbal to adjust the attitude and/or controlling the shooting apparatus to adjust the shooting parameter according to the one or more movement directions includes:
in response to the one or more movement directions including the front-back direction, controlling the shooting apparatus to adjust a focal length.

7. The method of claim 6, wherein adjusting the focal length of the shooting apparatus includes at least one of:
controlling the shooting apparatus to adjust the focal length of the shooting apparatus to zoom in or out the target object in the shot image; or
controlling the shooting apparatus to adjust the focal length of the shooting apparatus to maintain a size of the target object in the shot image unchanged.

8. The method of claim 5, wherein adjusting the gimbal or the shooting parameter according to the one or more movement directions includes:
in response to the one or more movement directions including the horizontal direction, controlling the gimbal to adjust a yaw angle of the gimbal to follow the one or more target body key points.

9. The method of claim 5, wherein adjusting the gimbal or the shooting parameter according to the one or more movement directions includes:
in response to the one or more movement directions including the vertical direction, controlling the gimbal to adjust a pitch angle of the gimbal to follow the one or more target body key points.

10. The method of claim 1, wherein obtaining one or more target body key points includes:
in response to a selection operation in the shot image, determining the one or more target body key points in the shot image.

11. The method of claim 1, wherein obtaining one or more target body key points includes:
automatically determining the one or more target body key points in the shot image according to a key point template.

12. The method of claim 1, wherein obtaining the one or more target body key points includes:
performing skeletal point detection on the shot image to obtain the one or more body key points of the target object in the shot image;
obtaining the one or more target body key points from the one or more body key points.

13. The method of claim 1, further comprising:
after controlling the gimbal to adjust the attitude and/or controlling the shooting apparatus to adjust the shooting parameter according to the one or more target body key points, controlling the shooting apparatus to shoot.

14. A gimbal control device comprising:
one or more processors; and
one or more memories storing one or more executable instructions that, when executed by the one or more processors, cause the one or more processors to:
display a shot image in a user interface and detect one or more body key points of a target object according to the shot image collected by a shooting apparatus carried by a gimbal;
in response to a selection operation performed on the user interface, determine one or more target body key points from the one or more body key points; and
control the gimbal to adjust an attitude and/or controlling the shooting apparatus to adjust a shooting parameter according to the one or more target body key points.

15. The device of claim 14, wherein the processor is further configured to:
form a key point trajectory according to the one or more target key points, the one or more target body key points including a plurality of target body key points, and the key point trajectory including movement trajectories of the plurality of target body key points in a plurality of images; and
control the gimbal to adjust the attitude and/or controlling the shooting apparatus to adjust the shooting parameter according to the key point trajectories.

16. The device of claim 14, wherein the processor is further configured to:
determine one or more movement directions of the one or more body key points in the key point trajectory; and
control the gimbal to adjust the attitude and/or controlling the shooting apparatus to adjust the shooting parameter according to the one or more movement directions.

17. The device of claim 16, wherein each of the one or more movement directions includes a front-back direction, a horizontal direction, or a vertical direction.

18. The device of claim 17, wherein the processor is further configured to:
in response to the one or more movement directions including the front-back direction, control the shooting apparatus to adjust a focal length of the shooting apparatus.

19. The device of claim 18, wherein the processor is further configured to:
in response to the one or more movement directions including the front-back direction, control the shooting apparatus to a focal length of the shooting apparatus to zoom in or out the target object in the shot image; and/or
in response to the one or more movement directions including the front-back direction, control the shooting apparatus to the focal length of the shooting apparatus to maintain a size of the target object in the shot image unchanged.

20. A gimbal system comprising:
one or more processors; and
one or more memories storing one or more executable instructions that, when executed by the one or more processors, cause the one or more processors to:
display a shot image in a user interface and detect one or more body key points of a target object according to the shot image collected by a shooting apparatus carried by a gimbal;
in response to a selection operation performed on the user interface, determine one or more target body key points from the one or more body key points; and
control the gimbal to adjust an attitude and/or controlling the shooting apparatus to adjust a shooting parameter according to the one or more target body key points.
